(19) United States
(12) Patent Application Publication
(10) Pub. No.: US 2002/0028109 A1
(43) Pub. Date: Mar. 7, 2002

(54) Outside leakage detection system for landfill liner

(76) Inventors: Jae Seong Rhee, Seoul (KR); Min Woo Jung, Seoul (KR)

Correspondence Address: Carter, Ledyard & Milburn, 1401 Eye Street, N.W., Suite 300, Washington, DC, 20005, US

(21) Appl. No.: 09/783,297

(22) Filed: Feb. 15, 2001

(30) Foreign Application Priority Data
Sep. 5, 2000 (KR) 2000-52480

(51) Int. Cl. B09B 5/00

(52) U.S. Cl. 405/129.5; 405/129.95

(57) ABSTRACT

The present invention is intended to provide an economical externally-monitored leakage detection system for landfill liner which is simple in structure to realize marked decrease in the manufacturing cost and the operation of which can be conducted manually in a convenient manner so that a position of damage in landfill liner may be detected and determined.

The present invention has the essential feature that the leakage detection system comprises electro-conductive graphite elements for detecting the difference in voltages as applied on a landfill, the electro-conductive graphite elements being buried in the soil at fixed intervals in arbitrary locations of the landfill provided with a leakage preventing liner, metal pins for fixing said electro-conductive graphite elements and for guiding the burying of the same graphite elements, sensing lines connected to said electro-conductive graphite elements and said metal pins, supporting rods for guiding said sensing lines, and a measuring device connected to said sensing lines, said measuring device being designed for measuring and recording the differential voltages detected at said electro-conductive graphite elements, whereby location of damage in a landfill liner may be detected.

### FIELD OF THE INVENTION

The present invention relates to an outside detection system for detecting a damage in a leakage preventing liner which was laid at the time of constructing a landfill to prevent percolation of water and more particularly to an outside leakage detection system for landfill liner which system is simple in construction to facilitate the manufacture and allows convenient manual measurement.

### BACKGROUND OF THE INVENTION

Conventionally, as a method for detecting landfill liner or leakage preventing material, there was a method of regularly analyzing the quality of the water contained in a monitoring well provided purposely. This method is however associated with problems in that appreciable analysis is possible only after contamination due to oozed water has proceeded considerably and the detection of the precise location of damage in the liner is practically impossible.

In a further method based on electrical measurement, various apparatuses and systems have been researched and developed. While this method has the advantage that automation of measurement is possible, it has also the disadvantage that measuring devices should be installed simultaneously with the construction of landfills and the cost for manufacture and installation is high.

### SUMMARY OF THE INVENTION

The object of the invention is to provide an economical outside leakage detection system for landfill liner which is simple in structure to realize marked decrease in the manufacturing cost and the operation of which can be conducted manually in a convenient manner so that a position of damage in landfill liner may be detected and determined.

The object described above can be achieved according to the invention by an outside leakage detection system for landfill liner which comprises electro-conductive graphite elements for detecting the difference in voltages as applied on a landfill, the electro-conductive graphite elements being buried in the soil at fixed intervals in arbitrary locations of the landfill provided with a leakage preventing liner, metal pins for fixing said electro-conductive graphite elements and for guiding the burying of the same graphite elements, sensing lines connected to said electro-conductive graphite elements and said metal pins, supporting rods for guiding said sensing lines, and a measuring device connected to said sensing lines, said measuring device being designed for measuring and recording the differential voltages detected at said electro-conductive graphite elements, whereby location of damage in a landfill liner may be detected.

Preferably, said metal pins are made of stainless steel.

Preferably, said metal pins are in form of cone.

Preferably, said sensing lines are made of copper.

### BRIEF DESCRIPTION OF THE DRAWINGS

FIG. 1 shows the schematic view for arranging outside leakage detection devices according to a preferred embodiment of the invention and

FIG. 2 shows the detailed view of an outside leakage detection device as shown in FIG. 1.

### DETAILED DESCRIPTION OF THE INVENTION

A preferred embodiment of the invention is described in detail below by referring to the accompanying drawings.

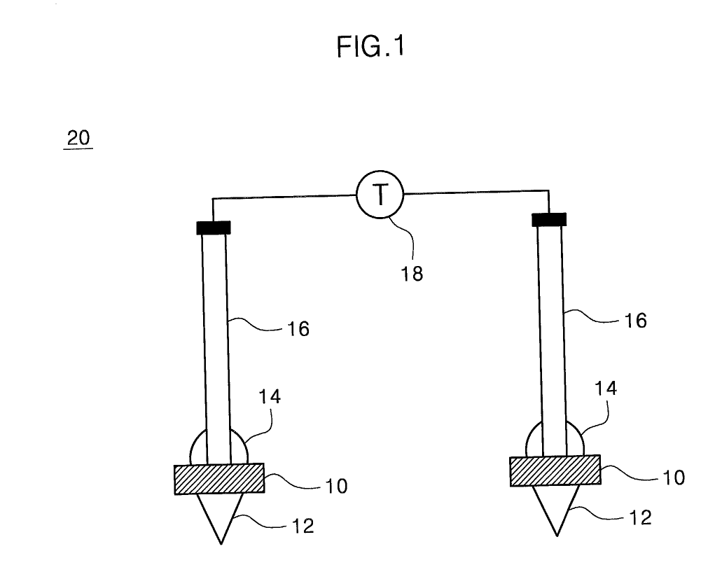

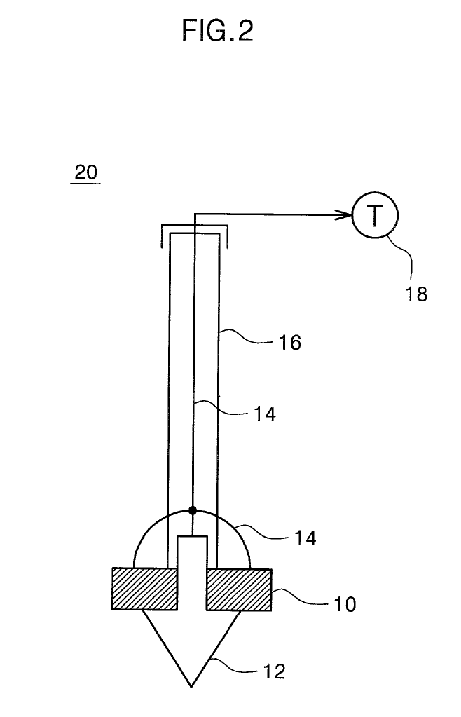

As shown in FIGS. 1 and 2, an outside leakage detection system 20 comprises conductive graphite elements 10, metal pins 12, supporting rods 16 and a measuring device 18, wherein a conductive graphite element 10 is disposed on a metal pin 12, and sensing line 14 is connected to both the conductive graphite element 10 and the metal pin 12 and further the sensing line is guided through the inside of the supporting rod 16 to be connected to the measuring device 18.

The conductive graphite elements 10 and metal pins 12 are buried in the soil at fixed intervals in arbitrary locations of the landfill provided with a leakage preventing liner. Preferably metal pins 12 consist of stainless steel so that they can be protected against the corrosion by oozing water when buried in the soil. Further, the metal pins 12 preferably have the form of cone so that they can be easily buried and secured in the soil.

The function of the outside leakage detection system according to a preferred embodiment of the invention is described particularly in conjunction with FIG. 1.

When a landfill provided with leakage preventing liner is applied with an electric voltage, the differential voltage between two outside leakage detection devices 20 connected to the measuring device 18 is transferred from the sensing area of the metal pins 12 and conductive graphite elements 10 to the measuring instrument 18 through sensing lines 14.

In that case, when the leakage preventing liner is not damaged, negligible difference in signals to the instrument 18 is detected because only minute potential drop through soil is detected between the two outside leakage detection devices 20, so that the intactness of the liner may be confirmed. On the other hand, if the liner is broken, the difference in voltages between the two outside leakage detection devices 20, or between the electro-conductive graphite elements 10 takes place due to the broken area, and thus the differential voltage is measured and recorded by the instrument 18 connected to the sensing lines 14.

Therefore, it is possible to detect any leakage from a landfill in advance for minimization of environmental contamination because the location of damage in a liner can be determined in a simple manner by using the measuring instrument 18.

As described above, the externally located detecting device according to the present invention allows advance detection of a damaged position in a landfill liner based on the voltage distribution and potential differences. Various effects are attained that include the reduction in manufacturing cost due to the simple construction of the detecting system and determination of the precise position of damage through a manual measurement on one hand and the suppression of environmental pollution owing to the oozing water to a minimum on the other hand.

It is to be understood that, while the invention was described only with respect to a preferred embodiment of an outside leakage detection system for landfill liner, the invention is never restricted to that embodiment and a variety of modifications and alterations would be possible to a man skilled in the art by referring to the description or drawings presented and within the technical idea of the invention and thus those modifications or alterations are to fall within the scope of the invention, which scope should be limited only by the attached claims.

What is claimed is:

1. An outside leakage detection system for landfill liner which comprises:
electro-conductive graphite elements for detecting the difference in voltage as applied on a landfill, the electro-conductive graphite elements being buried in the soil at fixed intervals in arbitrary locations of the landfill provided with a leakage preventing liner;
metal pins for fixing said electro-conductive graphite elements and for guiding the burying of the same graphite elements;
sensing lines connected to said electro-conductive graphite elements and said metal pins;
supporting rods for guiding said sensing lines; and
a measuring device connected to said sensing lines, said measuring device being designed for measuring and recording the differential voltages detected at said electro-conductive graphite elements,
whereby location of damage in a landfill liner may be detected.

2. The system according to claim 1, wherein said metal pins are made of stainless steel.

3. The system according to claim 1, wherein said metal pins are in the form of a cone.

4. The system according to claim 2, wherein said metal pins are in the form of a cone.

5. The system according to claim 1, wherein said sensing lines are made of cooper.
